(19) United States
(12) Patent Application Publication
(10) Pub. No.: US 2025/0373539 A1
(43) Pub. Date: Dec. 4, 2025

(54) DIVERSITY ROUTER INCORPORATED IN NETWORK SYSTEM

(71) Applicant: NORTHROP GRUMMAN SYSTEMS CORPORATION, Falls Church, VA (US)

(72) Inventors: Peter B. Houser, Poway, CA (US); Naomi A. Ramos, San Diego, CA (US); Tiffany Amber Lynn Reyes, San Diego, CA (US)

(21) Appl. No.: 18/678,702

(22) Filed: May 30, 2024

(51) Int. Cl. H04L 45/24

(52) U.S. Cl. CPC H04L 45/24

(57) ABSTRACT

A diversity router system for routing data across multiple paths includes a controller to receive a data packet and to split the data packet into a plurality of shards and a diversity router that includes one or more interfaces coupled to one or more networks and configured to receive the plurality of shards from the controller, at least one processor, and at least one machine readable storage medium storing one or more protocols comprising a diverse paths routing (DPR) protocol. Instructions of the DPR protocol inspects the shards to determine whether an indication for diversity exists in the shards, determines a plurality of paths through the networks, assign the shards to the plurality of paths, and transmitting the shards through the networks via the assigned paths.

### BACKGROUND

Routers typically determine the best path to reach a desired destination, and then route all data traffic to the destination over the best path. Routers use standard routing protocols such as Open Shortest Path First (OSPF) routing protocol and Multiprotocol Label Switching (MPLS) routing protocol, to determine a single path across a network that dictates how packets should be routed. This optimizes network performance (e.g., bandwidth or latency) but this emphasis on a single path may create vulnerabilities that can be exploited by an adversary. Types of routers, include core router, edge router, distribution router, wireless router, and virtual router. These routers may be chosen based on needs of connectivity, bandwidth, wireless capability, security, flexibility, and mech network capability. For wireless networks that require mobility and frequent changes, Kinetic Mesh protocol such as InstaMesh™ networking protocol may be used. Kinetic Mesh is better able to accommodate rapid change and significant scaling while maintaining low end-to-end latency and high data throughput.

Communications generally desired more resiliency, including greater privacy and greater reliability, even in the face of adverse or hostile events. Routers with the conventional protocols that select a single route are subject to adverse events such as physical failures or cyber attack. This situation can be mitigated by “path picking” schemes within an overall network management structure. However, such schemes may be unreliable and also subject to adverse events. Even with secondary paths or techniques for quick failover, the failure of links can have severe consequences.

### SUMMARY

We define a “diversity router” as being any router that has been modified to prefer routing packets across various distinct paths rather than across a single preferred path. Embodiments of the disclosed invention provide a diversity router that uses a novel routing protocol (algorithms) that prefers path diversity and thereby improves resiliency across a network. Instead of routing data packets via a single determined path across a network, embodiments of the diversity router route the data packets, potentially across a selected set of attractive, enabled, available paths, using an algorithm that promotes diversity in the overall routing methodology. This is particularly valuable when used in path-rich networks, for example, with a Transport Layer 4 protocol such as ResilNet™ that breaks packets into shards that are then preferably routed across diverse paths. The diversity router will be complementary with a Layer 4 encoding and interleaving protocol such as ResilNetTM. Features of embodiments of ResilNetTM are described in Applicant's U.S. Pat. No. 11,729,092 (“the '092 patent”), the entire contents of which are incorporated herein by reference.

Embodiments of the disclosed invention also provide a network system that includes one or more diversity routers. Embodiments of the network system may break data packets into multiple shards and the shards are then preferably routed across diverse spatial, temporal and/or encoding paths by the diversity routers.

These advantages and others are achieved, for example, by a diversity router system for routing data across multiple paths. The diversity router system includes a diversity router that includes one or more interfaces coupled to one or more networks and configured to receive data from the networks and transmit data to the networks. The interfaces are configured to receive packets. The diversity router further includes at least one processor and at least one non-transitory, machine-readable storage medium storing one or more protocols including a diverse paths routing (DPR) protocol that includes instructions that cause the at least one processor to execute operations to route the packets through the networks. The operations include steps of inspecting packets to determine whether an indication for diversity exists in the packets, determining a plurality of paths through the networks when the indication for diversity exists in the packets, assigning the packets to the plurality of paths, and transmitting the packets through the networks via the assigned paths. The one or more protocols may include one or more selected from a group consisting of Open Shortest Path First (OSPF) routing protocol, Multiprotocol Label Switching (MPLS) routing protocol, and Kinetic Mesh routing protocol.

The diversity router system may further include a controller configured to receive a data packet and to split the data packet into a plurality of shards. The data packet includes complete uscable information, and none of the individual shards contains uscable information of the data packet.

The indication for diversity may include a tag indicating that diversity is required. The inspecting the packets may include inspecting contents of the packets, and the indication for diversity may include a predetermined content. The inspecting the packets may include analyzing a source information of the packets and/or a destination information of the packets, and the indication for diversity may include a predetermined source information and/or a predetermined destination information. The inspecting the packets may include inspecting predetermined route information of the packets, and the indication for diversity may include predetermined characteristics of the route.

These advantages and others are achieved, for example, by a method for routing data across multiple paths by using a diversity router system that includes one or more protocols including a DPR protocol. The method includes steps of receiving packets to be transmitted to networks, inspecting the packets to determine whether an indication for diversity exists in the packets based on instructions included in the DPR protocol, determining a plurality of paths through the networks when the indication for diversity exists in the packets based on the instructions included in the DPR protocol, assigning the packets to the plurality of paths based on instructions included in the DPR protocol, and transmitting the packets through the networks via the assigned paths.

These advantages and others are achieved, for example, by a network system for securely transmitting data to a destination through networks. The network system includes a first host configured to transmit data through the networks, a second host configured to receive the data from the first host, and a plurality of communication paths coupled to the first host and second host. The first host includes a diversity router system that includes a diversity router that includes one or more interfaces coupled to one or more networks and configured to receive data from the networks and transmit data to the networks. The interfaces are configured to receive packets. The diversity router further includes at least one processor and at least one non-transitory, machine-readable storage medium storing one or more protocols including a DPR protocol that includes instructions that cause the at least one processor to execute operations to route the packets through the networks. The operations include steps of inspecting packets to determine whether an indication for diversity exists in the packets, determining a plurality of paths through the networks when the indication for diversity exists in the packets, assigning the packets to the plurality of paths, and transmitting the packets through the networks via the assigned paths.

### BRIEF DESCRIPTION OF THE DRAWINGS

The preferred embodiments described herein and illustrated by the drawings hereinafter are to illustrate and not to limit the invention, where like designations denote like elements.

FIG. 1 shows an exemplary diagram of a network system that illustrates features of a router operating with a conventional routing protocol.

FIG. 2 shows an exemplary diagram of a network system that illustrates features of a diversity router of the disclosed invention, which operates with Diverse Paths Routing (DPR) protocol.

FIG. 3 shows a diagram illustrating an embodiment of a network system of the disclosed invention, which includes one or more diversity routers.

FIG. 4 shows a diagram of a diversity router system of the disclosed invention.

FIG. 5 shows a diagram of router system at a destination node.

FIG. 6 shows a diagram of another embodiment of diversity router system.

FIG. 7 shows a diagram illustrating an exemplary hardware of the diversity router of the disclosed invention.

FIG. 8 shows a flowchart for a method for routing data across multiple paths by using a diversity router system.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

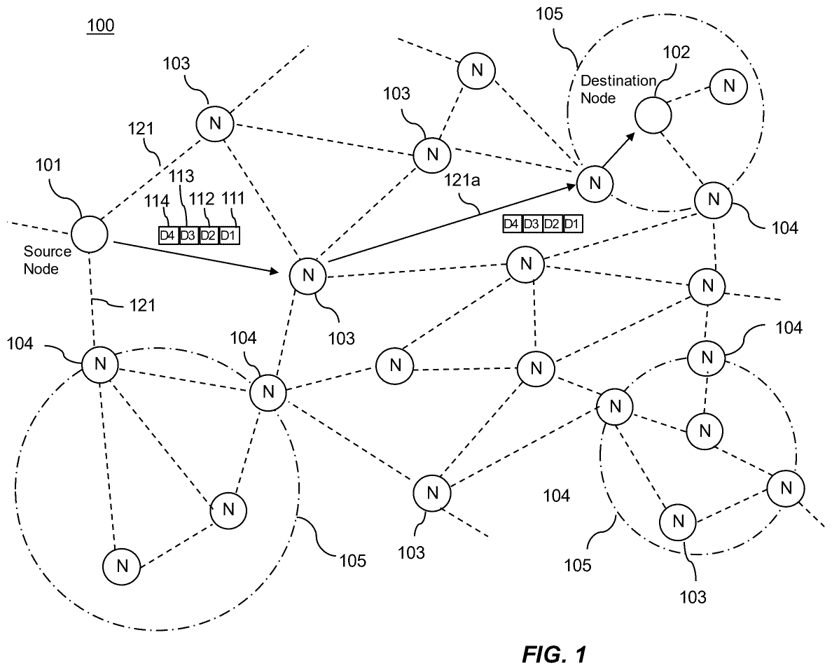

With reference to FIG. 1, shown is an exemplary diagram of a network system 100 that illustrates features of a router operating with a conventional routing protocol. The network system 100 may include a plurality of nodes that include source node 101, destination node 102, intermediate nodes 103, and border nodes 104 that include border routers at borders of network areas 105. The nodes may include conventional routers (not shown) that use conventional routing protocols such as OSPF and MPLS. The source node 101 is configured to send data to and destination node 102. The source node 101 may include data source that generates data packets D1-D4 111-114 or may receive data packets D1-D4 111-114 from an external source (not shown), and the router in the source node 101 is configured to transmit the data packets D1-D4 111-114 to destination node 102. There may be a plurality of available distinct paths 121, which may include one or more relay nodes, between the source node 101 and the destination node 102. The source and destination nodes 101, 102 may be referred to as a first and second hosts, respectively.

Based on the conventional routing protocol, the router in the source node 101 determines the best path among the available paths 121to transmit the data packets D1-D4 111-114 to the destination node 102. The best path may depend on the context of the routing algorithm implemented at that node. For example, the router of the source node 101 may determine the best path based on performance of the path or based on other required parameters of the network. Once the router of the source node 101 determines the best path, the router 101 with the conventional routing protocol transmits the data packets D1-D4 111-114 through the determined best path. For example, if the router 101 determines that the path 121a (shown in sold line) among the available paths 121 (shown in dotted lines) is the best path, all data packets D1-D4 111-114 are transmitted to the destination 102 through the path 121a. The router in the source node 101 may revise best new path later due to changes in the network environment. However, once the best new path is determined, the router in the source node 101 with conventional routing protocol transmits all data packets D1-D4 111-114 through the newly determined best path. In the other words, the router in the source node 101 with a conventional routing protocol is configured to select a single path and transmits data packets through the selected single path. However, this best-path approach has vulnerability issues. For example, it creates many single points of failure/disruption and so is vulnerable to adverse physical events, component failure, or adversary cyber or kinetic attack.

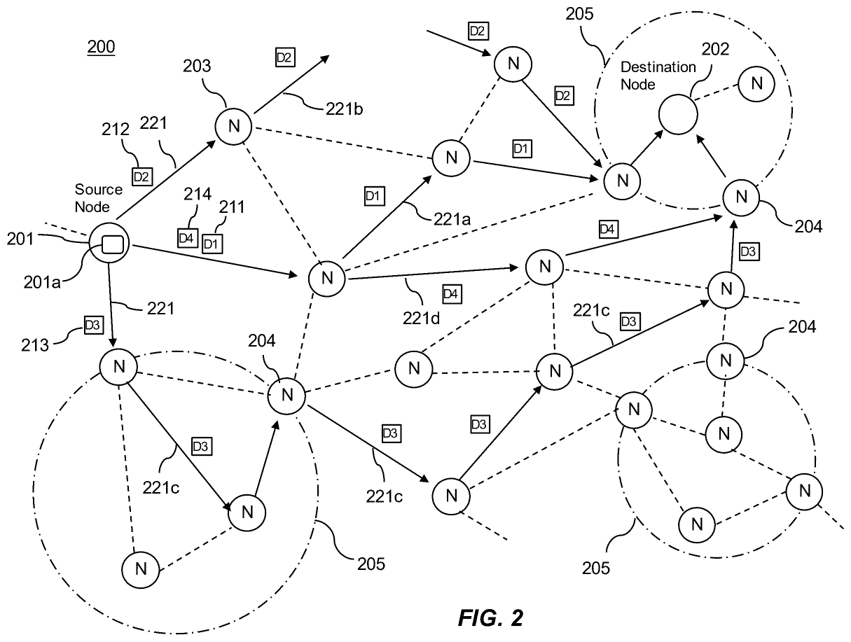

With reference to FIG. 2, shown is an exemplary diagram of network system 200 that illustrates features of a diversity router of the disclosed invention, which operates with Diverse Paths Routing (DPR) protocol. The network system 200 includes a plurality of nodes that include source node 201, destination node 202, intermediate nodes 203, and border nodes 204 that include border routers at borders of network areas 205. In the disclosed invention, the source node 201 includes a diversity router 201a. In an embodiment, some of the intermediate nodes 203 and border nodes 204 may have diversity routers. The diversity router 201a has the capability to be operated with the DPR protocol. The diversity router, however, also has the capability to be operated with convention routing protocol such as OSPF routing protocol and MPLS routing protocol. Herein, the conventional protocols such as such as OSPF and MPLS, which do not have the functionality of diversity routing, are referred to as non-DPR protocol.

The DPR protocols need not entirely replace conventional routing protocols, but the DPR protocol may simply modify or collaborate with those protocols to accomplish diversity routing paths. The DPR protocol may have instructions to instruct the diversity routers regarding how the routers incorporate the conventional routing protocols to diversify data packets over multiple paths. The diversity router is a router that includes DPR protocol and does not exclude other routing protocols. For example, the diversity router includes DPR protocol and may include routing protocols such as ODPF, MPLS and Kinetic Mesh network protocols. Consequently, the diversity router may include various types of routers such as core router, edge router, distribution router, wireless router, virtual router, and Kinetic Mesh router.

The source node 201 may include data source that generates data packets D1-D4 211-214 or may receive data packets D1-D4 211-214 from an external source (not shown), and the diversity router 201a is configured to transmit the data packets D1-D4 211-214 to destination node 202 over multiple paths. The source and destination nodes 201, 202 may be referred to as a first and second hosts, respectively.

While the conventional routers in the source node 101 selects the best single path among the available paths, the diversity router 201a, when operated with the DPR protocol, operates to diversify routing of the data packets D1-D4 211-214 through multiple routing paths that are distinct from one another. Herein, the “distinct from one another” may include, but not limited to, (i) separate physical path, e.g., fiber, or point to point RF with distinct antennas, (ii) distinct logical path, e.g., paths through a classic mesh network, (iii) Distinct frequencies while using the same antennas, (iv) distinct frequency hopping, (v) distinct CDMA codes, and (vi) distinct TDMA time slots. All of these technologies (i)-(vi) are appropriate for individual legs, and the overall path may consist of multiple legs that may each use a distinct technology. The diversity router 201a, when operated with the DPR protocol, focuses more on diversity of routing paths for transmissions of data packets, rather than a single best routing path. However, while focusing on the diversity of routing paths, the diversity router may also consider the routing paths that are better than some criteria for goodness on the “best” metric and may exclude really bad routing path as long as there are multiple available routing paths that satisfy the criteria.

Referring to FIG. 2, the source node 201 is coupled to a plurality of routing paths or communication paths 221 to the destination node 202. The source node 201 includes at least one diversity router 201a operating with protocols including a DPR protocol. The DPR protocol is configured to utilize a plurality of routing paths 221 to the destination node 202. The diversity router 201a may be configured to receive a plurality of data packets D1-D4 211-214, to distribute and assign the data packets D1-D4 211-214 to the determined plurality of routing paths 221 based on the DPR protocol, and to route the data packets D1-D4 211-214 to the destination 102 through the determined plurality of routing paths 221. In the example shown in FIG. 2, the diversity router 201a routes data packet D1 211 through routing path 221a, data packet D2 212 through routing path 221b, data packet D3 213 through routing path 221c, and data packet D4 214 through routing path 221d. The routing paths 221a-221d may include one or more spatial hops or relay nodes 203. For description purpose, FIG. 2 shows four (4) data packets, but the number of the data packets is not limited.

To diversify the data packets, the DPR protocol of the diversity router 201a includes unique routing algorithms. The diversity router 201a may use the routing algorithms that promotes diversity in the overall routing methodology. Based on the routing algorithms, the diversity router 201a determines multiple paths among the available paths to the destination 202, distributes and assigns data packets to the determined multiple paths, and transmits data packets through the determined multiple paths. The diversity router 201a may select all of the available paths or some of the available paths for the determined multiple paths, based on the routing algorithm of the DPR protocol and conditions of the networks. The diversity router 201a may distribute and assign data packets to the multiple selected paths to maximize the diversity. The diversity router 201a may assign data packets to the multiple selected paths randomly or to satisfy certain conditions that may be included in the routing algorithms.

In an embodiment, diversity router 201a may use the DPR protocol as the default protocol. In this configuration, the diversity router may distribute the data packets over multiple routing paths. In another embodiment, the diversity router 201a may be configured to select DPR protocol for diversity based on instructions. The diversity router 201a may have the capability to select protocols among the DPR protocol and the other protocols such as OSPF, based on instructions.

In an embodiment, a set of data packets, for which diversity is required, may include a tag to indicate that diversity is required for these data packets. For example, the data packets may be tagged for “route with diversity.” The diversity router 201a is configured to check if the received data packets include a tag with indication for diversity. When the diversity router 201a detect that the received data packets are tagged with any indication for diversity such as “route with diversity,” the diversity router 201a routes such data packets across a diversity of paths that may be available to the diversity router 201a. In order to further improve the resiliency, the diversity also may include temporal interleaving, while diversifying the sequencing and/or timing of the data packets.

The tag for “route with diversity” included in a set of data packets is different from addresses that may define nodes or routing paths of the data packets between the router and the destination. The tag for “route with diversity” is an indication for diversity that the set of data packets requires diversity in selecting paths for transmission. The diversity router 201a may inspect one or more tags included in the data packets. When the diversity router 201a receives a set of data packets including a tag for “route with diversity,” the diversity router 201a diversifies routing of the data packets through diverse paths between the at least one diversity router 201a and the destination 202 based on its own DPR protocol and information for the destination. In this example, the tag for indication for diversity works as a diversity routing trigger. The tag for “route with diversity” is an example of the indication that the set of data packets requires diversity in selecting paths for transmission. However, the indication for diversity is not limited to this type of tag, and other methods may be employed for the indication for diversity to notify the diversity router 201a that diversity of routing paths is required.

For example, when the diversity router 201a detects certain tags carried by data packets (or shards), such as Quality of Service, MPLS, or other tags, which are distinct from any specific diversity tag, diversity routing may be triggered. For another example, the diversity router 201a may be configured to inspect contents of data packets, and diversity routing may be triggered when the diversity router finds certain contents. For another example, the diversity router 201a may be configured to analyze or inspect source information and destination information of the data packets, and diversity routing may be triggered when the diversity router detects certain sources information and/or destinations information of the data packets. For another example, the diversity router 201a may be configured to inspect routes of data packets, and diversity routing may be triggered when the diversity router detects certain route characteristics (e.g., routes with more than a certain number of intermediates) of the data packets. These described above are examples of diversity routing triggers, and there may be other types of diversity routing triggers. If no diversity routing trigger is detected or diversity routing is not instructed by any way, then the diversity router 201a may route the data packets in accordance with a protocol that would otherwise be selected, such as such as OSPF and MPLS.

The diversity router 201a is useful when it is incorporated in the multi-path mesh network system such as ResilNet™, which breaks a data packet into multiple shards that are then preferably routed across diverse paths. By using the diversity router 201, resiliency and privacy of the mesh network system may be further enhanced. Applicant has previously conceived and implemented the method of breaking a packet into multiple shards at OSI Layer 4, encoding those shards, routing them to a destination, and then decoding the shards to recreate the packet. This method, which May be referred to as the ResilNet method, is described in the '092 patent. The ResilNet method will have the greatest effect on resiliency and privacy if the shards are routed across a diversity of paths. The disclosed invention addresses that need. Overall, the use of the ResilNet method with the diversity router of the disclosed invention greatly increases communications resiliency across the overall, heterogeneous network. It increases both privacy and reliability of packet transfers. This privacy will be valuable to both commercial and military users. For example, within a meshed Internet of Things, The ResilNet method with the diversity routing would greatly increase communications resiliency. For another example, a user's cell phone might connect simultaneously to multiple base stations to achieve resiliency. For another example, a swarm of drones or weapons might connect via an ad hoc mesh network with greater resiliency.

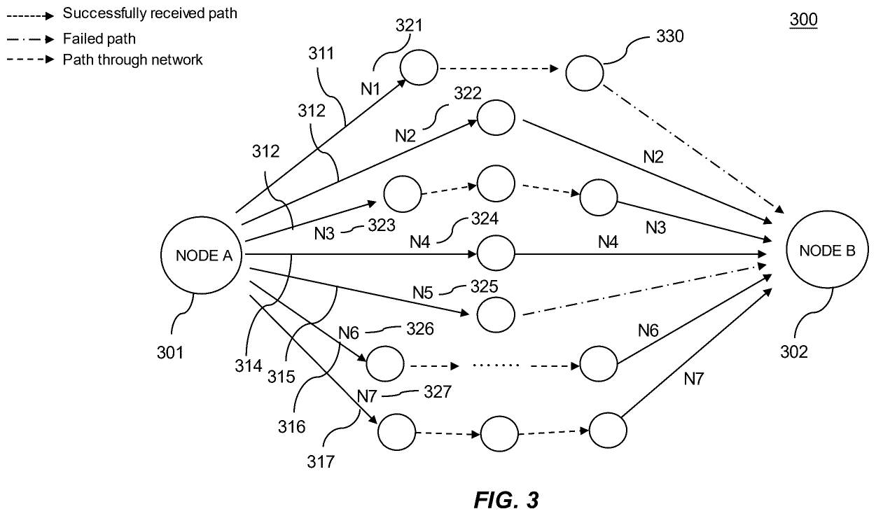

With reference to FIG. 3, shown is a diagram illustrating an embodiment of network system 300 which includes one or more diversity routers. For illustration purpose, FIG. 3 shows seven (7) distinct routing paths 311-317 between source node A 301 and destination node B 302. The source and destination nodes 301, 302 may be referred to as a first and second hosts, respectively. The source node A 301 receives data packet (DATA) 320 of information from an external source (not shown), which is to be transmitted from the source node 301 to the destination node 302. The source node 301 includes diversity router (DR) 303 to route the data packets 320 to the destination node 302.

Referring to FIG. 3, the source node 301 receives data packets, and identifies a data packet 320 of information for transmission to the destination node 302. The source node 301 uses a predetermined encoding method, such as Reed Solomon encoding, to translate and split the data packct 320 of information into N shards N1-N7 321-327. The shards N1-N7 321-327 may be tagged with an indication for diversity, such as “route with diversity,” to indicate that these shards require diversity in selecting routing paths for transmission.

The shards N1-N7 321-327 produced by Reed-Solomon encoding are non-identical from one another. The shards N1-N7 321-327 may be mathematically interrelated or correlated through the encoding processes; however, the shards N1-N7 321-327 are distinct from each other. None of the shards N1-N7 321-327 is a duplicate of the other. No individual shard contains any meaningful (or useable) information, and ‘M’ of ‘N’ shards are needed to decode uscable data. None of the shards individually contains decodable or uscable information to decode any part of the original data packet of information. Because the shards N1-N7 321-327 contains data that can only be decoded into uscable information with other shards and the decoding algorithm, even if the interceptor intercepts the shard (less than M shards), the interceptor cannot recover any information for the original data packet of information.

The diversity router in the source node 301 receives the shards N1-N7 321-327 and may check or detect any indication for diversity for the shards N1-N7 321-327. If the diversity router 303 detects that the shards N1-N7 321-327 are tagged with an indication for diversity, the diversity router 303 determines, based on its own DPR protocol, multiple distinct routing paths 311-317 for transmission of the shards N1-N7 321-327 and transmits the shards N1-N7 321-327 to the destination node 302 through the distinct routing paths 311-317. The routing paths 311-317 may include one or more relay nodes 330 coupled to the source node 301 and the destination node 302 to further increase diversity of the routing paths. The relay nodes 330 may be configured to receive some of the shards N1-N7 321-327 and direct the received shards to the next relay nodes or to the destination node 302. The relay nodes 330 may be configured to transmit the received shards through any one or more of omnidirectional wireless signals, directional wireless signals, communication wires, communication cables including optical cables, and any other types of data transfer or communication means. The paths with the relay nodes 330 may be paths with individual legs or paths with multiple legs. The paths may be fixed end-to-end routing paths such as OSPF or dynamic routing paths such as kinetic mesh. In an embodiment, the relay nodes 330 may be configured to operate with a protocol including the DPR protocol. The routing paths 311-317 may include mesh network schemes.

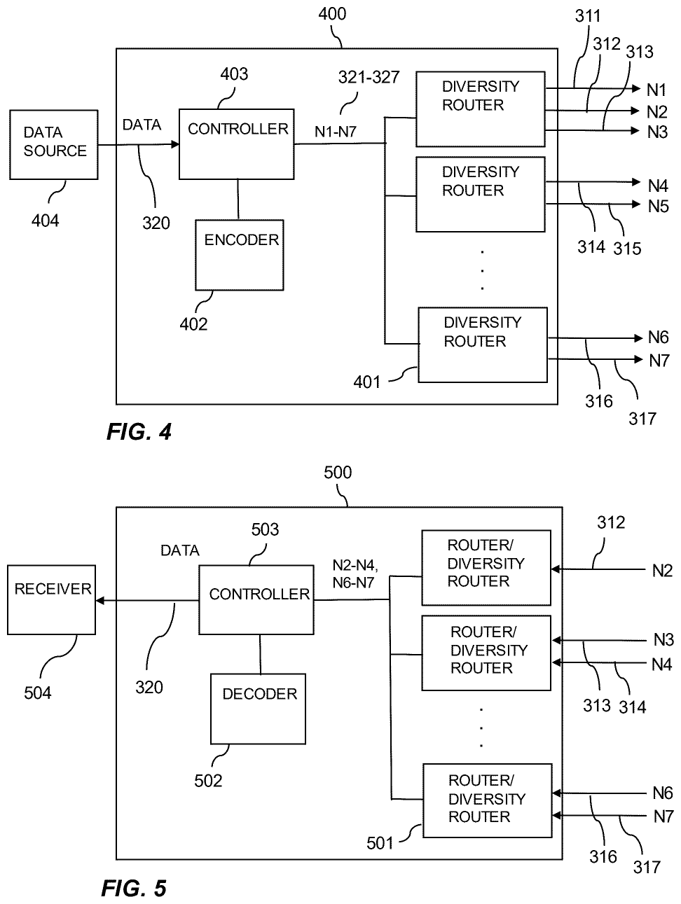

With reference to FIG. 4, shown is a diagram illustrating diversity router system 400 of the disclosed invention. The diversity router system 400 may be included in the source node 301. The diversity router system 400 includes one or more diversity routers 401, encoder 402, and controller 403. Multiple diversity routers may allow communications to continue even when adverse events disable one of the diversity routers. The controller 403 receives data packet 320, which includes complete uscable information, from the data source 404, and split the data packet 320 into a plurality of shards N1-N7 321-327. None of the individual shards N1-N7 321-327 may contain uscable information of the data packet 320. The shards N1-N7 321-327 may be distributed throughout the diversity routers 401. FIG. 4 exemplarily shows encoder 402 that may be required for some applications in which encoding data is necessary. However, the diversity router system 400 may not include the encode 402. The diversity router system 400 works even though data packets or shards are not encoded. Spreading the shards across routes, via the diversity routers 401, increases resiliency by decreasing the impact of any single route being compromised. When encoding process is required, the encoder 402 receives data packet 320, and encodes the data packet 320 by using a linear encoding method such as Reed-Solomon encoding process. The shards N1-N7 321-327 are sent to the one or more diversity routers 401. The diversity router 401 determines the diverse routing paths 311-317 and transmits the shards N1-N7 321-327 through the determined diverse routing paths 311-317.

In an embodiment, the controller 403 may tag the shards N1-N7 321-327 with an indication for diversity. However, the tagging process of the shards N1-N7 321-327 may be performed at any stage before the shards N1-N7 321-327 are sent to the diversity router 401. Alternatively, the data packet 320 for information may have been tagged with an indication for diversity before it is sent to the controller 403, and each of the shards N1-N7 321-327 may inherit the tag from the data packet 320. When encoder 402 is included in the diversity router system 400, the controller 403 may control the encoder 402 to encode the data. The controller 403 may include one or more processors and storage media that include instructions to control the encoder 402 and the diversity routers 401.

With reference to FIG. 5, shown is a diagram illustrating router system 500 at the destination such as the destination node 302. router system 500 includes router or diversity router 501, decoder 502 and controller 503. FIG. 5 exemplarily shows decoder 502 that may be required when the transmitted shards N2-N4 322-324 and N6-N7 326-327 are encoded. However, the router system 500 may not include the decoder 502 when decoding process is not required. In the example, shown in FIG. 5, the router/diversity router 501 receives shards N2-N4 322-324 and N6-N7 326-327 transmitted through the network with routing paths 312-314 and 316-317. The received shards N2-N4 322-324 and N6-N7 326-327 are sent to the controller 503. When decoding process is required, the original data packet 320 is recovered from the received shards N2-N4 322-324 and N6-N7 326-327 through decoding process via the decoder 502 such as reverse Reed-Solomon encoding. As described above, If the network system 300 is configured to utilize “M of N” encoding method (in this example, “5 of 7” encoding method), the destination node 302 can recover the original data packet 320 from the received ‘M’ shards (in this example, five (5) shards). The controller 503 may control the decoder 502 to decode the data. The controller 503 may include one or more processors and storage media that include instructions to control the decoder 502 and the diversity routers 501.

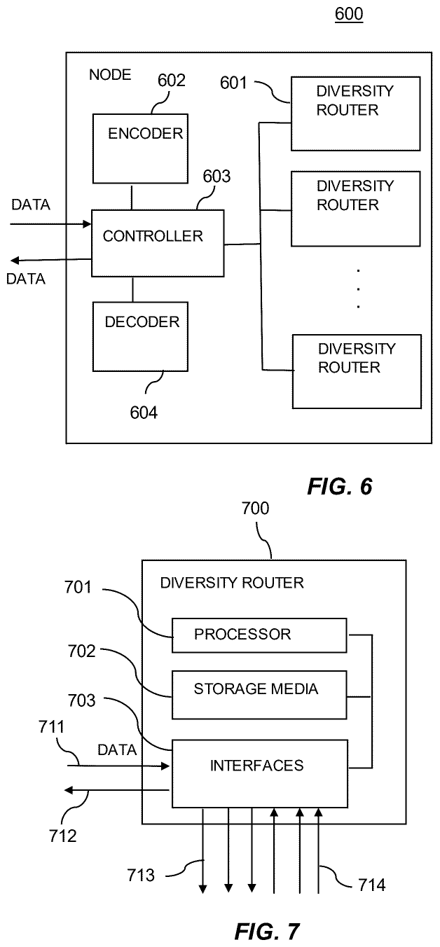

With reference to FIG. 6, shown is a diagram of another embodiment of diversity router system 600 that includes one or more diversity routers 601, encoder 602, decoder 604, and controller 603. FIG. 6 exemplarily shows encoder 602 and decoder 604 that may be required for some applications. However, the diversity router system 600 may not include the encoder 602 and decoder 604. The functionalities of these elements are the same as described referring to FIGS. 4-5.

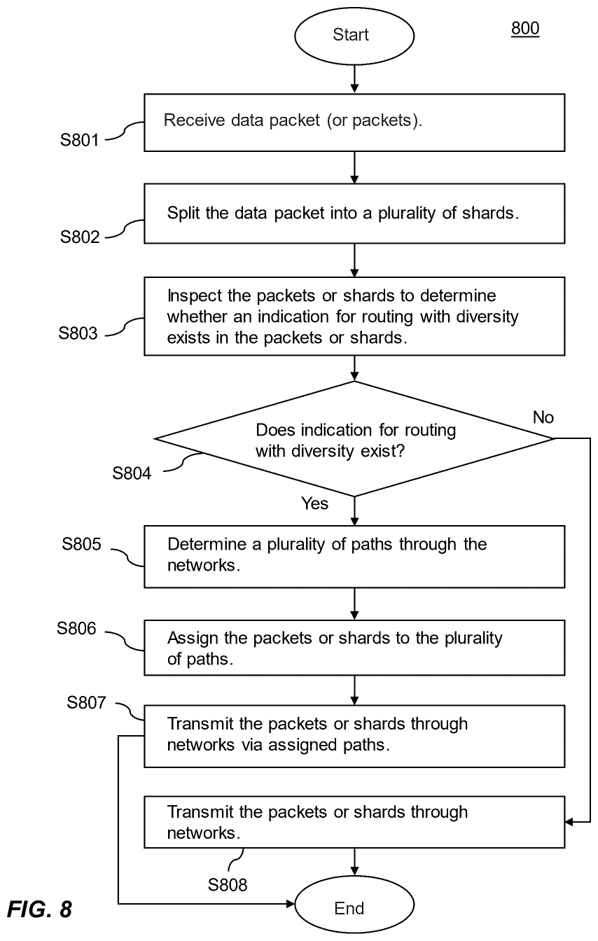

Referring to FIG. 7, shown is a diagram illustrating an exemplary hardware of the diversity router 700 of the disclosed invention. The diversity router 700 includes at least one processor 701, at least one machine readable storage medium 702, and one or more interfaces 703. The diversity router 700 may further include other digital devices (not shown) such as field-programmable gate array (FPGA) in order to achieve high data rates. The storage medium 702 may include various types of memory devices, but not limited to, such as read only memory (ROM), random access memory (RAM), non-volatile RAM and flash memory. The diversity router 700 is configured to store DPR protocol and instructions that are necessary for the diversity routing. The diversity router 700 may store the other routing protocols such as OSPF protocol, MPLS routing protocol, and Kinetic Mesh routing protocol. In an embodiment, these protocols and instructions may be stored in the one or more storage media 702. The DPR protocol includes instructions that cause the at least one processor 701 to execute operations to route the data packets through the networks. The one or more interfaces 703 are coupled to one or more networks and are configured to receive data from the networks and transmit data to the networks. The interfaces 703 may be coupled to one or more data sources/receivers or external devices to receive data 711 from the data sources/receivers or to transmit data 712 to the data sources/receivers. The interfaces 703 may be coupled to the controllers 403, 603 shown in FIGS. 4 and 6 to receive shards from the controllers 403, 603.

With reference to FIG. 8, shown a flowchart for a method 800 for routing data across multiple paths by using a diversity router system that includes one or more protocols that include a DPR protocol. A data packet or packets, which includes complete uscable information, is received, block S801. The data packet is split into a plurality of shards, block S802. In an embodiment, the step S802 may be omitted, and the diversity router receives a plurality of packets. In some cases, those packets may include shards that have been created by a distinct ResilNet process. A diversity router system may be defined to encompass both the diversity router and the ResilNet process that manipulates data outside of the routing itself. The diversity routing works even when ResilNet process is not applied. All diversity routers fundamentally operate on packets. Every packet contains a payload. In some cases, the payload of a “child” packet consists of a shard that has been created by applying ResilNet to the payload of a “parent” packet. In that context, we might choose to simply refer to the child packet as a shard; it may include shard data plus header information.

The packets or shards are inspected to determine whether an indication for routing with diversity exists in the shards, based on instructions of the DPR protocol, block S803. If the indication for routing with diversity exists in the packets or shards, block S804, a plurality of paths through the networks are determined based on the instructions of the DPR protocol, block S805. The packets or shards are respectively assigned to the plurality of paths, based on instructions of the DPR protocol, block S806. The packets or shards may be assigned to the paths by using, for example, a diversity-promoting algorithm. The packets or shards are transmitted through the networks via the assigned paths, block S807. If the indication for routing with diversity does not exists in the packets or shards in block S804, the packets or shards are transmitted to a destination, block S808, without the processes shown in blocks S805-S807.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A diversity router system for routing data across multiple paths, comprising:
a diversity router, comprising:
one or more interfaces coupled to one or more networks and configured to receive data from the networks and transmit data to the networks, wherein the interfaces are configured to receive packets;
at least one processor; and
at least one non-transitory, machine-readable storage medium storing one or more protocols comprising a diverse paths routing (DPR) protocol that includes instructions that cause the at least one processor to execute operations to route the packets through the networks, the operations comprising:
inspecting packets to determine whether an indication for diversity exists in the packets;
determining a plurality of paths through the networks when the indication for diversity exists in the packets;
assigning the packets to the plurality of paths; and
transmitting the packets through the networks via the assigned paths.

2. The diversity router system of claim 1 wherein the one or more protocols further comprise one or more selected from a group consisting of Open Shortest Path First (OSPF) routing protocol, Multiprotocol Label Switching (MPLS) routing protocol, and Kinetic Mesh routing protocol.

3. The diversity router system of claim 1 further comprising a controller configured to receive a data packet and to split the data packet into a plurality of shards, wherein the data packet includes complete useable information.

4. The diversity router system of claim 3 wherein none of the individual shards contains useable information of the data packet.

5. The diversity router system of claim 1 wherein the indication for diversity comprises a tag indicating that diversity is required.

6. The diversity router system of claim 1 wherein inspecting the packets comprises inspecting contents of the packets, and wherein the indication for diversity comprises a predetermined content.

7. The diversity router system of claim 1 wherein inspecting the packets comprises analyzing a source information of the packets and/or a destination information of the packets, and wherein the indication for diversity comprises a predetermined source information and/or a predetermined destination information.

8. The diversity router system of claim 1 wherein inspecting the packets comprises inspecting predetermined route information of the packets, and wherein the indication for diversity comprises predetermined characteristics of the route.

9. A method for routing data across multiple paths by using a diversity router system that includes one or more protocols comprising a diverse paths routing (DPR) protocol, comprising:
receiving packets to be transmitted to networks;
inspecting the packets to determine whether an indication for diversity exists in the packets, based on instructions included in the DPR protocol;
determining a plurality of paths through the networks when the indication for diversity exists in the packets, based on the instructions included in the DPR protocol;
assigning the packets to the plurality of paths, based on instructions included in the DPR protocol; and
transmitting the packets through the networks via the assigned paths.

10. The method of claim 9, further comprising:
receiving a data packet that includes complete, useable information;
splitting the data packet into a plurality of shards.

11. The method of claim 10 wherein none of the individual shards contains useable information of the data packet.

12. The method of claim 9 wherein the indication for diversity includes a tag indicating that diversity is required.

13. The method of claim 9 wherein inspecting the packets comprises inspecting contents of the packets or the data packet, and wherein the indication for diversity comprises a predetermined content.

14. The method of claim 9 wherein inspecting the packets comprises analyzing a source information of the packets and/or a destination information of the packets, and wherein the indication for diversity comprises a predetermined source information and/or a predetermined destination information.

15. The method of claim 9 wherein inspecting the packets comprises inspecting predetermined route information of the packets, and wherein the indication for diversity comprises predetermined characteristics of the route.

16. A network system for securely transmitting data to a destination through networks, comprising:
a first host configured to transmit data through the networks;
a second host configured to receive the data from the first host; and
a plurality of communication paths coupled to the first host and second host, wherein the first host comprises a diversity router system that comprises:
a diversity router, comprising:
at least one interface coupled to one or more networks and configured to receive data from the networks and transmit data to the networks, wherein the at least one interface is configured to receive packets;
at least one processor; and
at least one non-transitory machine readable storage medium storing one or more protocols comprising a diverse paths routing (DPR) protocol that includes instructions that cause the at least one processor to execute operations to route the packets through the networks, the operations comprising:
inspecting the packets to determine whether an indication for diversity exists in the packets;
determining a plurality of paths through the networks when the indication for diversity exists in the packets;
assigning the packets to the plurality of paths; and
transmitting the packets through the networks via the assigned paths.

17. The network system of claim 16 wherein the one or more protocols further comprise one or more selected from the group consisting of Open Shortest Path First (OSPF) routing protocol, Multiprotocol Label Switching (MPLS) routing protocol, and Kinetic Mesh routing protocol.

18. The network system of claim 16 further comprising a controller configured to receive a data packet and to split the data packet into a plurality of shards, wherein the data packet includes complete useable information.

19. The network system of claim 18 wherein none of the individual shards contains useable information of the data packet.

20. The network system of claim 16 wherein the indication for diversity comprises a tag indicating that diversity is required.

21. The network system of claim 16 wherein inspecting the packets comprises inspecting contents of the packets or the data packet, and wherein the indication for diversity comprises a predetermined content.

22. The network system of claim 16 wherein inspecting the packets comprises analyzing a source information of the packets and/or a destination information of the packets, and wherein the indication for diversity comprises a predetermined source information and/or a predetermined destination information.

23. The network system of claim 16 wherein inspecting the packets comprises inspecting predetermined route information of the packets, and wherein the indication for diversity comprises predetermined characteristics of the route.
